(19) United States
(12) Patent Application Publication
(10) Pub. No.: US 2020/0189911 A1
(43) Pub. Date: Jun. 18, 2020

(54) METHOD AND APPARATUS FOR PORTABLE ON-DEMAND HYDROGEN GENERATION

(71) Applicant: AlGalCo, LLC, Indianapolis, IN (US)

(72) Inventors: Kurt C. Koehler, Indianapolis, IN (US); Matthew R. Hendey, Indianapolis, IN (US)

(21) Appl. No.: 16/685,576

(22) Filed: Nov. 15, 2019

Related U.S. Application Data
(60) Provisional application No. 62/768,429, filed on Nov. 16, 2018.

(51) Int. Cl. C01B 3/32; H01M 8/0606; B01J 19/24; B01J 23/08; B01J 19/00; B01J 4/00

(52) U.S. Cl. CPC C01B 3/326; H01M 8/0606; B01J 19/2415; C01B 2203/1041; B01J 19/0053; B01J 4/001; C01B 2203/066; B01J 23/08

(57) ABSTRACT

The present invention discloses hydrogen generation systems and methods of using the same. More particularly, hydrogen is generated on demand by injecting liquid feedstock onto a solid aluminum alloy containing a catalyst. The hydrogen may then be stored or used as fuel for various types of energy conversion, such as internal combustion engines or fuel cells. The hydrogen generation reaction oxidizes the alloy to alumina, which can recycled back into the original alloy using conventional smelting methods.

### CROSS REFERENCE TO RELATED APPLICATION

This application claims the benefit of priority to U.S. Provisional Patent Application Ser. No. 62/768,429, filed Nov. 16, 2018, incorporated herein by reference.

### FIELD OF INVENTION

The present invention discloses hydrogen generation systems and methods of using the same. More particularly, hydrogen is generated on demand by injecting liquid feedstock onto a solid aluminum alloy containing a catalyst. The hydrogen may then be stored or used as fuel for various types of energy conversion, such as internal combustion engines or fuel cells. The hydrogen generation reaction oxidizes the alloy to alumina, which can recycled back into the original alloy using conventional smelting methods.

### BACKGROUND OF THE INVENTION

The reliance on fossil fuels for generating energy is not a long-term sustainable model. For centuries, power generation has been dominated by the use of non-renewable resources, such as coal, oil, and gas. In the latter decades of the 20^{th} century, concerns began to mount regarding the limits to these non-renewable resources, especially oil. Some have calculated that world oil reserves will begin to diminish beginning by the year 2030 and possibly sooner as global demand for oil and its refined products increases.

Concurrent with the concerns over depletion of these power generation resources has been the growing fear of the effects of emissions not only from the use of, but also from the production of, non-renewable resources. While the debate over the contribution of burning fossil fuels to the phenomenon of global warming rages, there is no question the production and use of coal and oil are significant sources of air pollution.

The fear of scarcity and deleterious environmental effects has generated growing pressure to develop so-called “alternative” power or energy sources, especially from renewable sources. Thus, significant effort has gone into developing sun, wind, and wave power generation systems. Thus far, these renewable energy sources have been demonstrated to have value in large-scale power generation, such as supplying electricity to the grid. For obvious reasons, these renewable resources are inadequate for small power supply needs, such as powering cell phones or operating an automobile. For smaller power needs, rechargeable batteries or power cells have been developed and utilized with good success. Of course, these rechargeable electrical sources still rely upon large-scale electricity generation.

Beginning in the last third of the 20^{th} century and continuing into the third millennium, significant time, money, and energy have been devoted to developing so-called “green” sources of power and energy that are renewable and have a much lower environmental impact than their fossil fuel cousins. One proposed solution has been to use hydrogen as a fuel. Hydrogen-fuel cell and hydrogen-internal combustion engine (ICE) technology has been successfully demonstrated for use in powering an automobile. However, many draw backs inherent with the generation, storage, and transport of hydrogen have hampered its widespread development and usage. One significant problem has been the fact that it takes a significant amount of energy to extract hydrogen from water. Another problem is that hydrogen is difficult to store since it must be highly compressed in large, high pressure-safe storage tanks, or maintained in a liquefied form in cryogenically cooled tanks. In either case, the storage requirements render the use of hydrogen in automobiles problematic and, in much smaller apparatuses, virtually unthinkable.

The United States Environmental Protection Agency (EPA) has implemented several regulations requiring the reduction of greenhouse gas (GHG) emissions since the passing of the Clean Air Act (CAA) in 1970. Within the CAA, the EPA defines the National Ambient Air Quality Standards (NAAQS), which relate the maximum allowable GHG emissions output for automotive manufacturers and fleet vehicles. Within these regulations, there exist various limits on carbon monoxide (CO), carbon dioxide (CO2), nitrous oxides (NOx), particulate matter (PM), un-burnt hydrocarbons (HyCx), and sulfur oxides (SOx).

The World Health organization in their annual assessment of ambient air pollution demonstrates that nearly 3 million people die each year due to exposure to GHG emissions. It has also been determined that GHG emissions account for nearly $184 billion in total damages to various economic sectors in the United States alone. Since passing the CAA, the EPA has issued several major amendments to the document implementing stricter reduction regulations in an attempt to curb such economic and human losses.

Exacerbating this problem is the fact that the number of miles driven in the U.S. has increased nearly 200% since the passing of the CAA. Despite the increase, aggregate emissions (PM, CO, NOx, SO2, VOC's and Pb), have steadily declined since 1970. Carbon dioxide (CO2) emissions, however, are still increasing. Although the rate of increase has dropped from 50% in 2004 to 25% today, CO2 emissions are still increasing even while aggregate emissions are falling. Thus, the current focus is on CO2 reduction.

It is anticipated that efforts will continue to increase regulations to reduce emissions, with the focus on automotive manufacturers, state, municipal and industrial fleets, as well as over-the-road trucks. Fleet managers especially will be challenged with meeting the more stringent requirements in order to avoid incurring monetary fines and penalties. As many state and local municipalities are not able to purchase new vehicles every year, these stricter regulations become increasingly difficult to meet for older vehicles.

The average fuel price per gallon has increased dramatically since 1970, growing from an average of $0.36 per gallon to $2.45 per gallon in 2015. This is an approximate 681% increase with the highest average price taking place in 2012 ($3.64 per gallon, a 1011% increase over 1970). While the average price per gallon has decreased in recent years, the overall trend remains up. The U.S. Energy and Information Administration (EIA) provides gasoline price predictions based upon market and usage trends. These trends suggest fleet managers will have to continue to combat increased fuel costs.

In response to these issues, it is quite relevant that the combustion of hydrogen is perhaps the most “green” power source possible. The byproduct or “exhaust” of hydrogen combustion is merely water without the greenhouse gases that are exhausted from combustion of more traditional fuels. U.S. Pat. Nos. 7,938,879 and 8,080,233, both of which are held by the Purdue Research Foundation, involve the generation of hydrogen on demand as an alternative fuel. Thus, the environmental impact is lessened significantly and any contribution to the global warming phenomenon is minimized. Rather than being required to replace older but mechanically viable vehicles, it would be most practical to somehow retro fit these units in order to reduce their GHG emissions, improve their overall fuel economy and save money on operating costs.

Thus, there is a need for hydrogen generation systems and processes that avoid the inherent problems with current technology, namely hydrogen storage and fossil fuel extraction. There is also a need for a hydrogen fuel cell that can be used on virtually any scale ranging from powering a large machine, such as an automobile, to powering a small appliance such as a cell phone or tablet.

### SUMMARY OF THE INVENTION

The present invention comprises a novel apparatus and method of injecting a metered amount of a liquid hydrogen-containing oxidant feedstock, such as, for example, water, onto a solid aluminum alloy containing galinstan, a eutectic alloy of gallium, indium and tin, to produce and deliver hydrogen on demand. The injection is achieved by controllably operating water injectors in a precise sequence with a precise quantity of water over a precise interval of time. The injection pressure will be created with an air-over-water method of about 6 PSI relative to the H₂ output pressure, meaning as the H₂ pressure rises from zero to 5 PSI, the water pressure will climb concurrently up to 11 PSI in order to achieve no more than about 6 PSI relative pressure in the reaction container in order to ensure a consistent rate of water injection. In some embodiments, the water pressure is controlled to maintain the hydrogen gas pressure at not more than about 5 PSI. Both the compressed air and output gas are monitored using pressure transducers coupled to a microcontroller that manages the entire process.

The solid alloy containing the catalyst can be safely stored in a dry location without special consideration, both before and after reacting with water. The alloy after use is oxidized to alumina (aluminum oxide), which can then be recovered and recycled back into the original alloy an indefinite number of times by deploying conventional aluminum industry smelting methods.

The combustion of hydrogen in a common ICE has several benefits. Hydrogen burns very quickly due to its high flame propagation rate, reducing the need for gasoline within the cylinder as the oxygen sensors on the vehicle continuously clean the air/gasoline mixture. In addition, the byproduct of hydrogen and oxygen combustion is simply water. As there is no carbon present in either hydrogen or water, the creation of carbon monoxide (CO) and carbon dioxide (CO₂) is eliminated.

### BRIEF DESCRIPTION OF THE DRAWINGS

The features of this disclosure and the manner of attaining them, will become more apparent and the disclosure itself will be better understood by reference to the following description of preferred embodiments of the disclosure taken in conjunction with the accompanying drawings, wherein:

FIGS. 1 and 2 are perspective views of a housing for encasing an apparatus for carrying out this invention;

FIG. 3 is an exploded view of the apparatus housing shown in FIGS. 1 and 2;

FIG. 4 is an isolated perspective view of the apparatus provided by the invention that is carried within the housing shown in FIGS. 1 and 2;

FIG. 5 is an exploded perspective view of the apparatus of FIG. 4;

FIG. 6 is a top plan view of the upper housing panel of the apparatus shown in FIGS. 4 and 5;

FIG. 7 is a front plan view of the apparatus of FIGS. 4 and 5;

FIG. 8 is a partial cut-away view of the water vessel of the apparatus shown in FIGS. 4 and 5;

FIG. 9 is a partial cut-away view of a single reactor of the apparatus shown in FIGS. 4 and 5;

FIG. 10 is a top perspective view of the reactor of the apparatus shown in FIGS. 4, 5 and 8, depicted in an exploded fashion;

FIG. 11 is a side plan view of the alloy holder carried within the apparatus reactor shown in FIG. 10;

FIG. 12A is a perspective view of the top of a reactor canister.

FIG. 12B is a perspective view of a hook locked in place through an aperture on the reactor module lid.

FIG. 12C is a perspective view of a hook held in place with a locking tab through the aperture of the reactor module lid.

FIG. 13 is a schematic illustration of the electrical and fluid connections of the apparatus according to a preferred embodiment of this invention;

FIG. 14 is a schematic illustration of the fluid connections only of the apparatus according to a preferred embodiment of this invention; and

FIGS. 15 and 16 are flow charts illustrating an exemplary automated process for carrying out the method according to an embodiment of the invention.

FIG. 17 is a graph depicting carbon dioxide (CO2) emissions from a test vehicle during hydrogen delivery events.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF ONE OR MORE EMBODIMENTS

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. Unless otherwise specified, the terms “about” or “approximately,” when used in connection with a numerical value, should be interpreted as meaning within 5% of the most precise digit of stated value. For example, “about 1” refers to 0.95 to 1.05, while “about 1.0” refers to 0.995 to 1.005.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new and novel method and apparatus for creating and delivering hydrogen on demand from a hydrogen-containing oxidant feedstock and catalyst reaction are disclosed and shown herein. In the following description, for purposes of explanation, numerous specific details are set forth in order to provide a thorough understanding of the present invention. It will be evident, however, to one skilled in the art that the present invention may be practiced without these specific details. The present disclosure is to be considered merely as an exemplification of the invention, and is not intended to limit the invention to the specific embodiments illustrated by the figures or description below.

The technology of this invention lowers the demand for gas and diesel by substituting hydrogen as a supplemental fuel. Inside an ICE, hydrogen burns first due to its unique, inherent characteristics. The use of hydrogen increases the efficiency of the motor, thereby reducing the need for liquid fuels. Combusting hydrogen produces no harmful emissions, only water vapor. An ICE operating on supplemental hydrogen does not require any additional modification.

Hydrogen is a most basic material. Its qualities and characteristics are well-known and long-established science. An aspect of this novel technology is a solid alloy comprised of aluminum and catalyst. In some embodiments, ratio of aluminum and catalyst each range from 0.01% to 99.99% by weight. In further embodiments, the alloy is about 90% aluminum and about 10% catalyst by weight. In certain embodiments, the alloy is at least 90% aluminum and more than 0%, but not more than 10%, catalyst by weight. Any type of hydrogen-containing oxidant (e.g., water, although others are also known) added to the alloy will instantly generate hydrogen on demand, thereby eliminating the need for high-pressure storage and transportation of hydrogen gas. The rate and quantity of hydrogen production can be controlled and adjusted as needed for the end application.

After the alloy has reacted with water, it becomes aluminum oxide (also known as “alumina”). Alumina can be captured and recycled an indefinite number of times through established and common techniques well-known in the aluminum industry. The result is the cost of the alloy and, therefore, the cost of hydrogen, decreases each time the alloy is deployed. This fact makes it possible for supplemental hydrogen to become cost competitive compared to gasoline at current pricing levels.

Moreover, the infrastructure for reducing alumina into aluminum has existed in this country for over 100 years and is vastly underutilized. Adoption of this novel technology will not only reduce the demand for oil and reduce emissions from the transportation sector, but revitalize the domestic aluminum industry as well.

A sustainable hydrogen feedstock will also assist in stretching out global supplies of oil by decreasing reliance on fossil fuels. Such can be accomplished without the need for government mandates and/or subsidies.

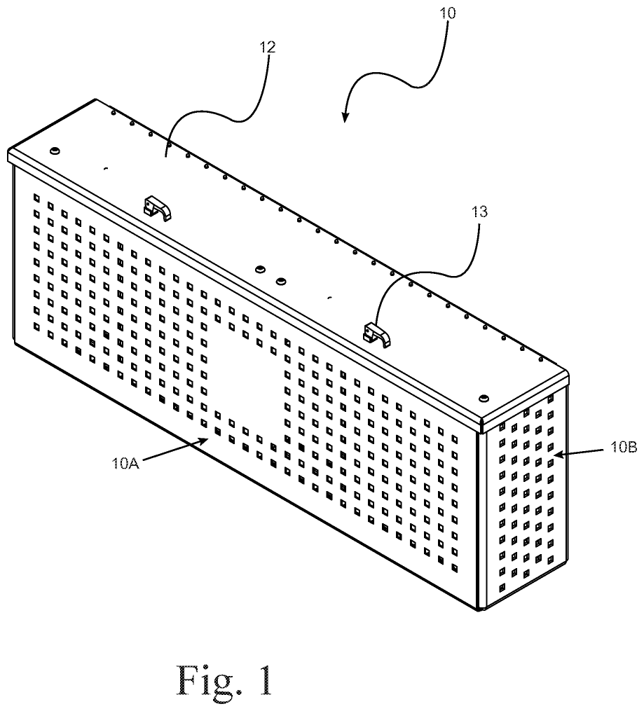

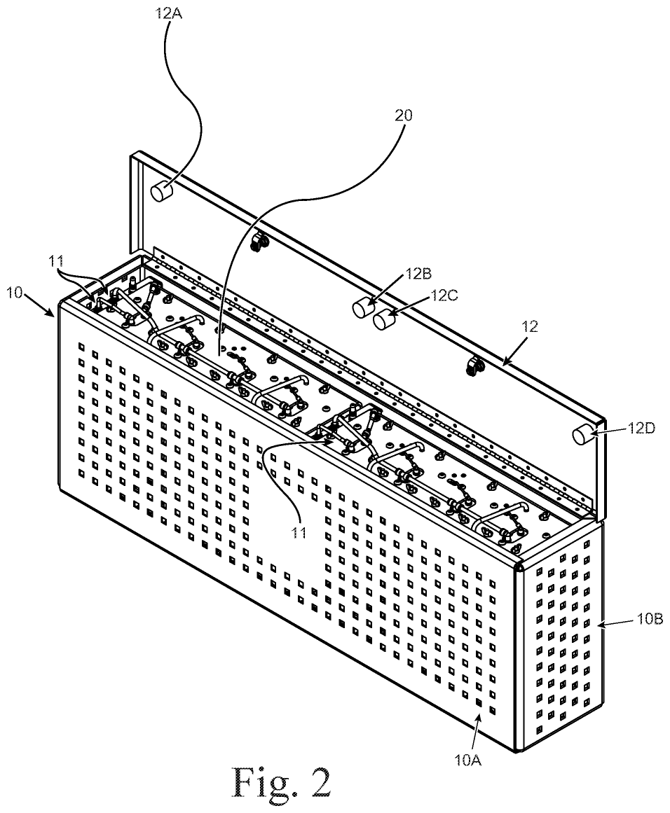

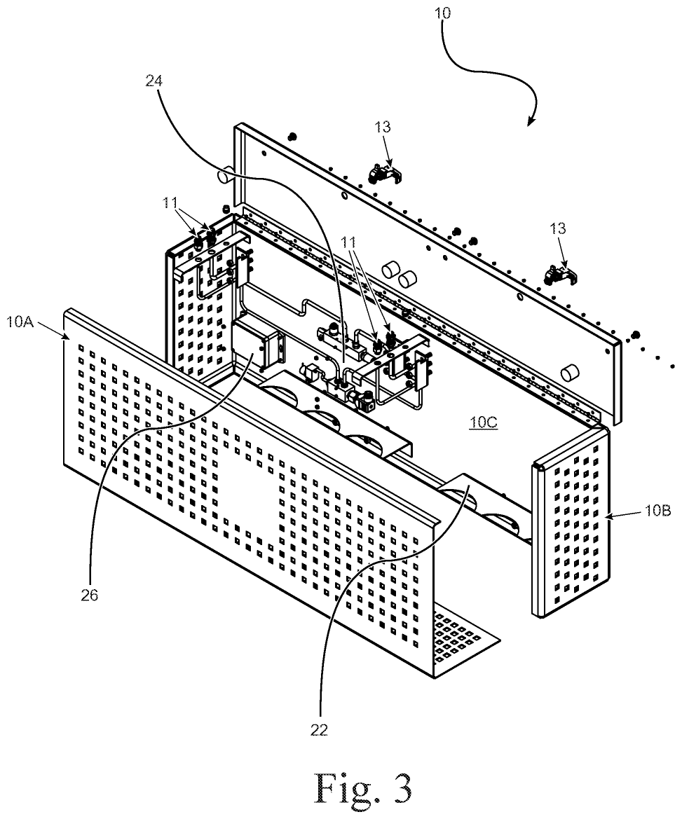

The present invention will now be described more specifically by referencing the appended figures representing preferred embodiments. As shown in FIGS. 1-3, the preferred embodiment of the current invention provides a vented casing or enclosure 10 for housing the apparatus of this invention. Enclosure 10 preferably includes perforated walls 10A and 10B (as best shown in FIG. 1), as well as a lid panel 12 securable in a closed position by one or more compression lever locks 13. Lid 12 also preferably carries one or more compressible bumpers 12A-D. FIG. 2 shows the enclosure 10 carrying within its interior reactor module 20, while FIG. 3 depicts an exploded view of enclosure 10 without the reactor module 20. As shown in FIG. 3, reactor module 20 is carried within the enclosure 10 abutting reactor saddles 22. FIG. 3 also shows a gas train 24 and a system controller 26 carried within the enclosure 10 affixed to rear enclosure panel 10C.

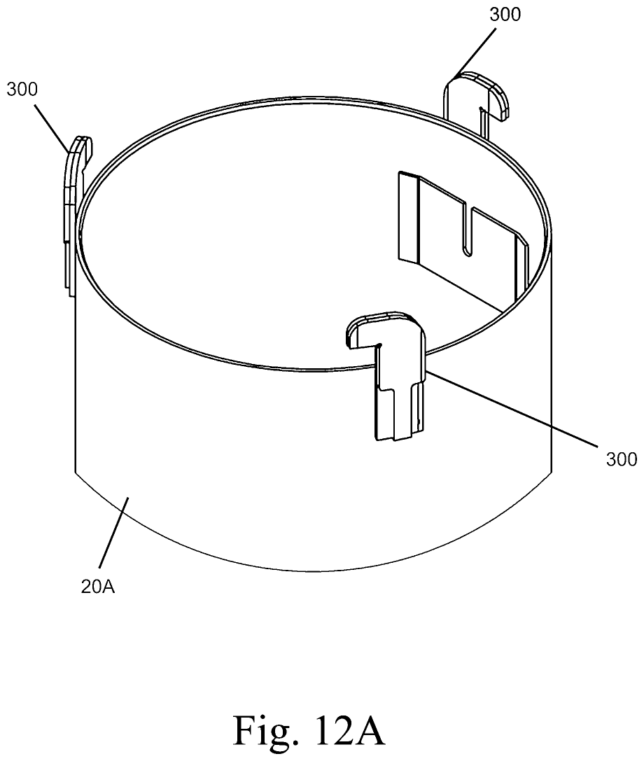

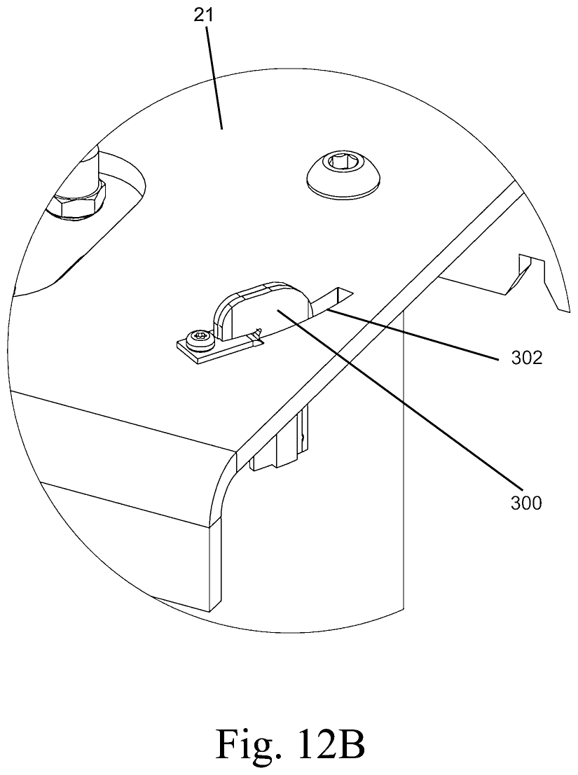

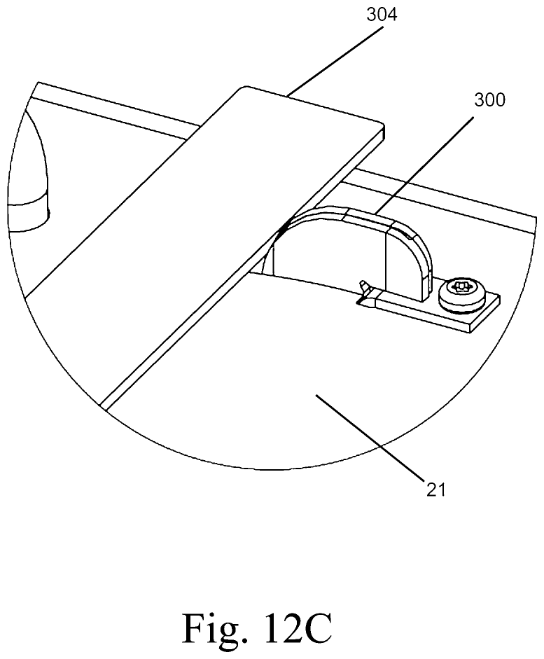

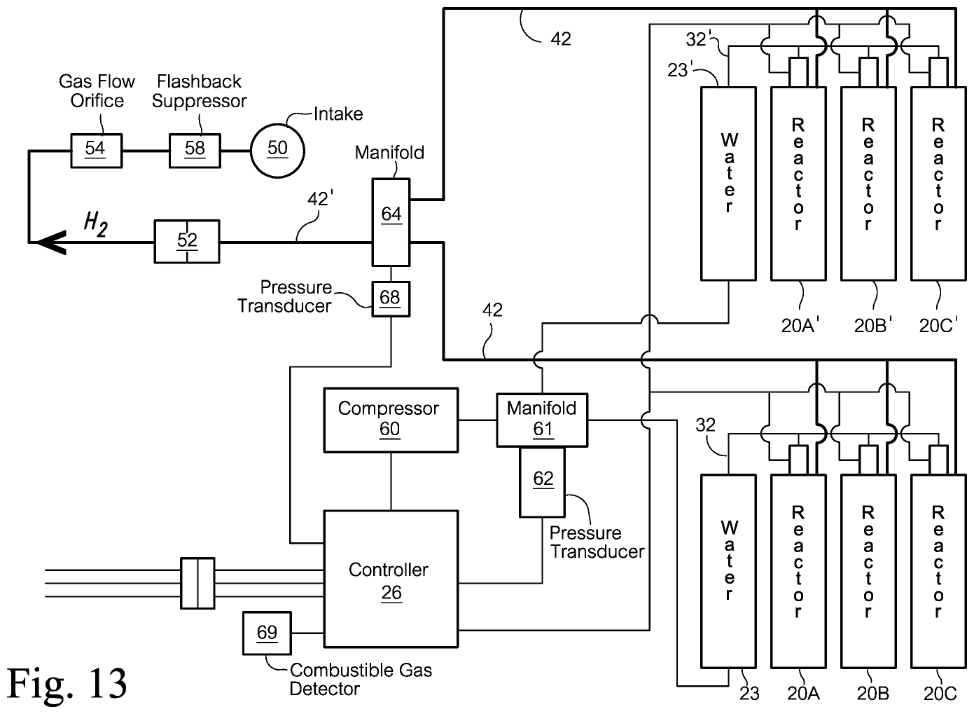

Gas train 24 provides a path for both compressed air (from compressor 60 shown schematically in FIGS. 12 and 13) and resulting hydrogen gas from the reaction modules. The two (2) gas trains are centrally located and then plumbed to four quick disconnects 11 (FIG. 2, FIG. 3), preferably two (2) for the ingoing compressed air and two for the outgoing hydrogen gas. The quick disconnects are located for easy access and connection to the two (2) reactor modules 20 and 20′, but could be scaled to accommodate more reactor modules as needed.

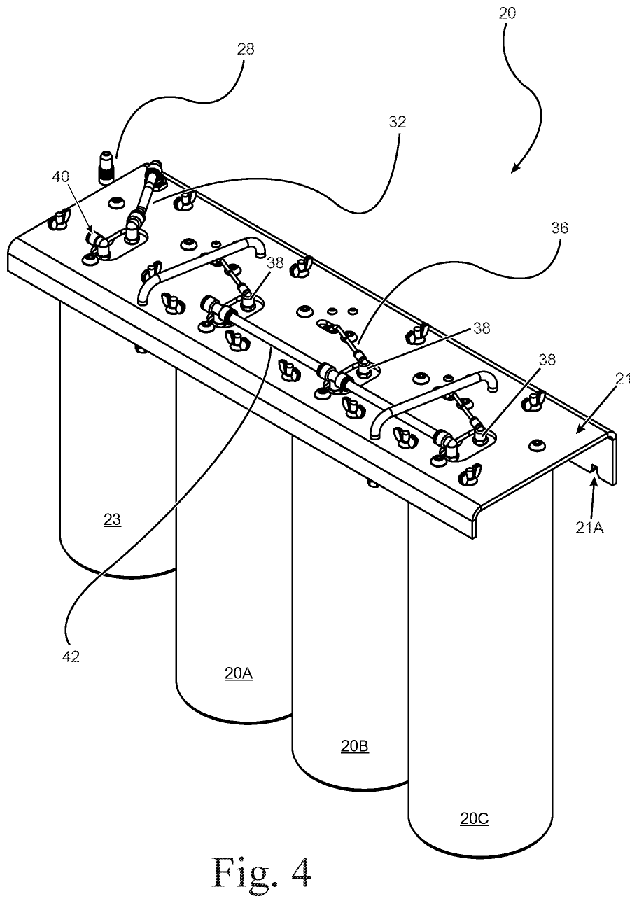

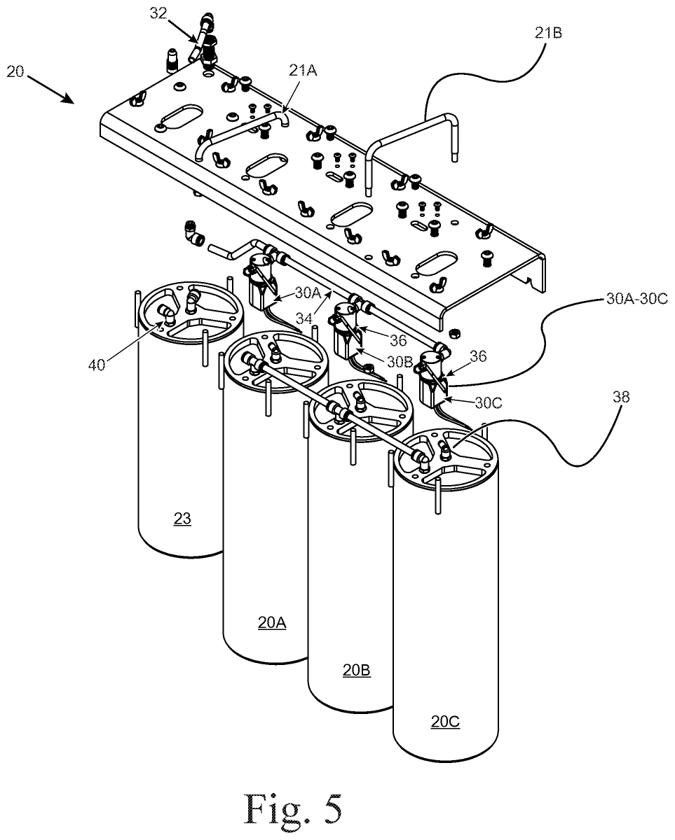

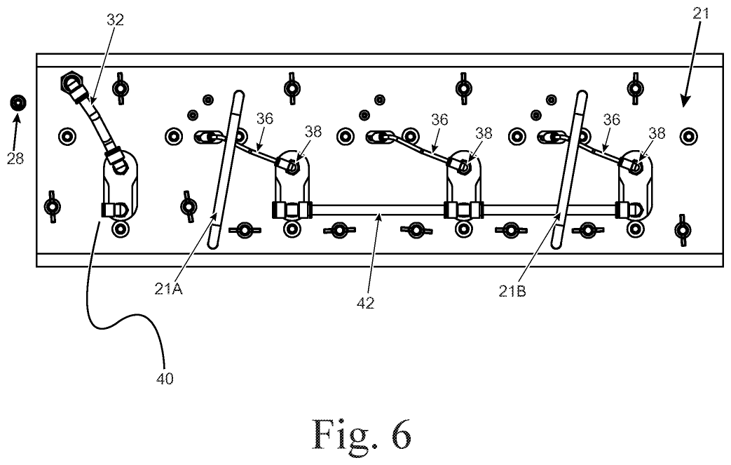

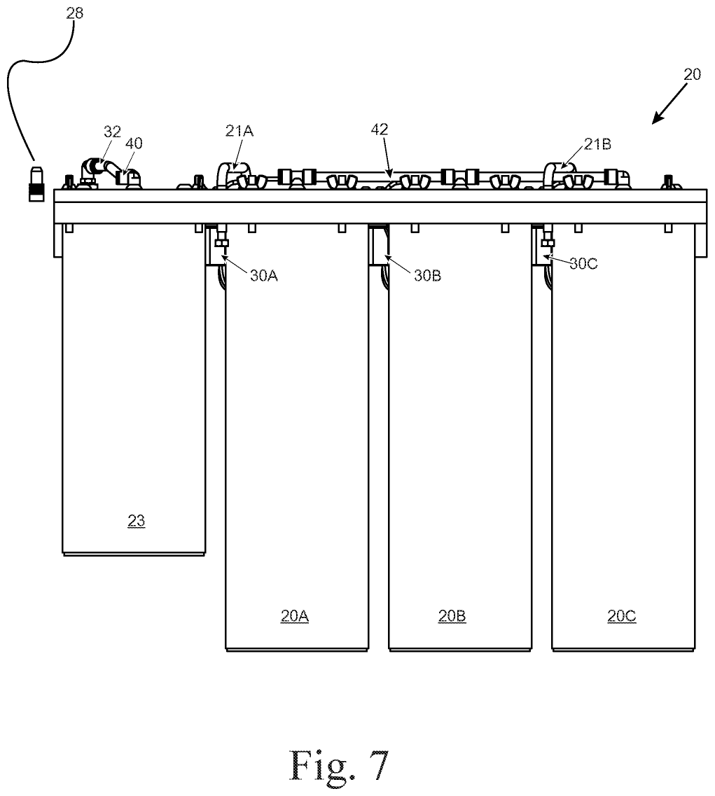

Referring now to FIGS. 4 and 5, reactor module 20 provided by this invention is shown in an assembled mode in FIG. 4 and in an unassembled (exploded) mode in FIG. 5. FIGS. 6 and 7 depict a top view of panel 21 of reactor module 20 and a side plan view of module 20 in an assembled form, respectively. In one embodiment, reactor module 20 includes three (3) hydrogen reactors 20A, 20B, and 20C, in combination with a water vessel 23. In a more preferred embodiment, the system of this invention includes two (2) reactor modules 20 and 20′, with the second module 20′ including a first reactor 20A′, a second reactor 20B′, and a third reactor 20C′, in combination with a second water vessel 23′. Top panel 21 is preferably included with one or more hanger notches 21A to allow for the indexing and proper positioning of the module 20 when carried within the enclosure 10. As will be discussed further below and will become more apparent in connection with such discussion, reactor module 20 also preferably includes a sealed electrical plug 28, a series of water valves 30A, 30B, and 30C, for introducing pressurized water into each of the reactors 20A-20C, as determined and controlled by controller 26.

Reactor module lid 21 preferably includes one or more lifting handles 21A and 21B for facilitating the removal and replacement of module 20 into enclosure 10 for refueling purposes.

As determined and controlled by controller 26, pressurized water is delivered from water vessel 23 to each of the reactors 20A-20C via pressurized water outlet 32, first water conduit 34, valves 30A-30C, and second water conduit 36, which introduce water to and through water injection inlet 38. Water vessel 23 also includes compressed air inlet 40. The hydrogen gas generated by reactors 20A-20C is carried away from the reactors and, in this embodiment, ultimately enters into an ICE (not shown) via hydrogen conduits 42.

It is to be appreciated that the form, fit and function of first module 20 applies equally as well to the form, fit, and function of second reactor module 20′.

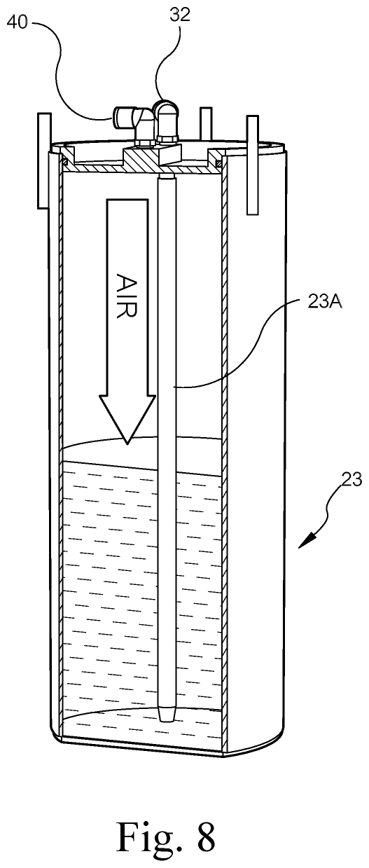

FIG. 8 depicts a partial cut-away view of water vessel 23 including water outlet 32, compressed air inlet 40, and water pickup tube 23A. As pressurized air is introduced into vessel 23 via inlet 40, water is forced upwardly and outwardly through pickup tube 23A and water outlet 32 into first water conduit 34.

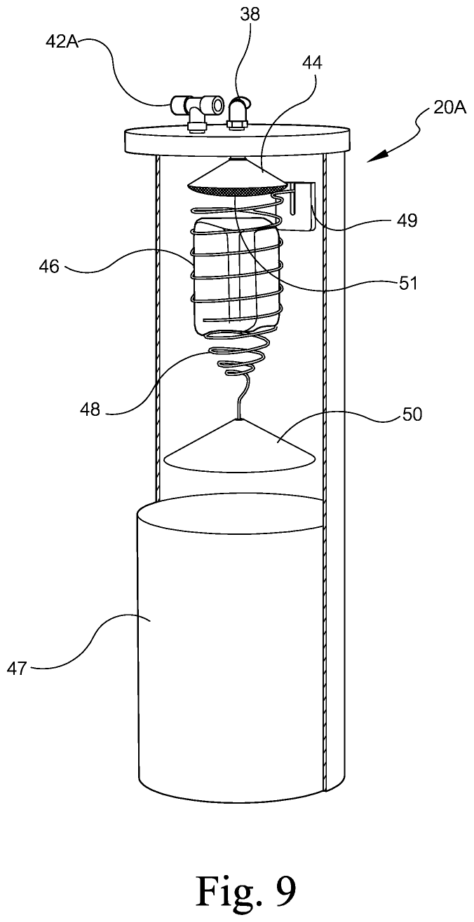

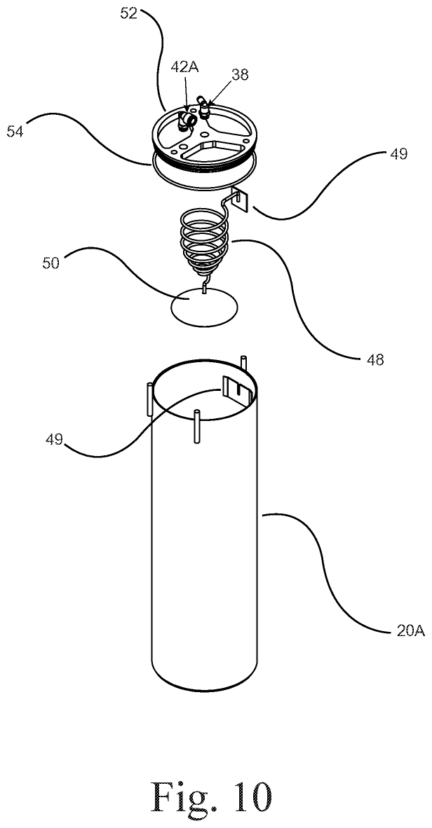

FIGS. 9 and 10 show, respectively, a partial cut-away view of reactor 20A and an exploded perspective view of reactor 20A. In operation, as water is introduced to reactor 20A through water inlet 38, the water first comes into contact with a condensate hood 44 (not shown in FIG. 10 for clarity) and thereafter catalyst-alloy 46 carried by spring-holder 48, which is secured in a fixed position and attached to the interior wall of reactor 20A by bracket 49. As the injected water contacts and reacts with catalyst-alloy 46, it produces spent alloy and catalyst 47, which drops downwardly within reactor 20A, engaging a cone-shaped diverter 50 and collecting in the lower portion of reactor 20A (as best shown in FIG. 9). Diverter 50 is preferably attached to the lower end of spring holder 48. Reactor 20A may also include a seal cap 52, an O-ring 54, and a hold-down screen 51. Screen 51 is preferably defined by a stainless steel mesh placed over the condensate hood 44 for preventing alumina from rising up from the alloy out of the holder when water is added and possibly clogging the water source. Screen 51 also serves to direct the water from the injectors to improve coverage of the alloy.

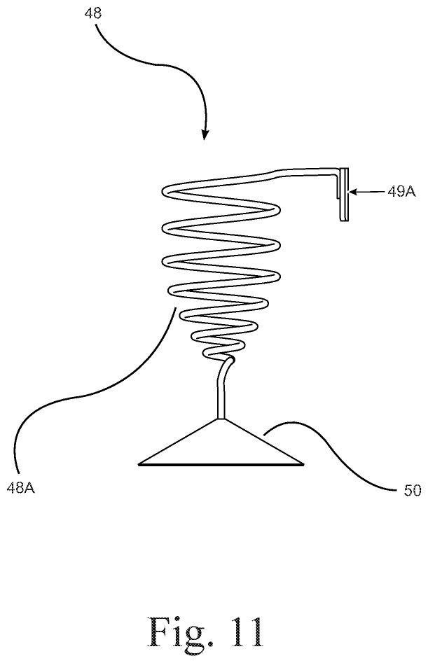

Experimentation has shown that a preferred shape or form of holder 48 of the alloy and catalyst 46 is a spring form as shown in FIG. 11, including shedding gaps 48A for allowing spent alloy and catalyst to drop downwardly within the interior of reactor 20A. Experimentation has further shown that there is a preferred pitch provided to the shedding gaps 48A based on the height and diameter of the multiple wraps (here, wraps 1-5) that define holder 48, as best shown in Table A below:

TABLE A
Configurations of Holder

| | Pitch (mm) | Height (mm) | Diameter (mm) |
|---|---|---|---|
| Wrap 1 | 18 | 0 | 53.975 |
| Wrap 2 | 18 | 18 | 53.975 |
| Wrap 3 | 14 | 50 | 53.975 |
| Wrap 4 | 10 | 74 | 31.75 |
| Wrap 5 | 6 | 90 | 9.525 |

FIG. 12A shows protruding hooks 300 on the top of a reactor canister 20A. The hooks 300 can be inserted into corresponding apertures 302 on the reactor module lid 21 in order to provide a reactor locking mechanism. Once the hooks 300 are inserted into the apertures 302, the canister 20A can be rotated as to lock the hooks 300 in place, as shown in FIG. 12B. Additionally, a locking tab 304 can be placed on the back of the hook to further hold it in place, as shown in FIG. 12C. To release, the locking tab 304 can be lifted and the canister 20A can be rotated and pulled downwardly to remove the hooks 300 from within apertures 302. The hooks 300 can be spot welded on the canisters 20A. Since the assembly preferably employs an aluminum top plate 21, the hooks 300 are, in some embodiments, cladded with harder metal such as low carbon steel as not to wear out the plate prematurely. While these FIGS. 12A, 12B, and 12C depict one means for removably securing a reactor canister 20A to the reactor module lid 21, alternative configurations of fasteners, friction fits, straps, and other known means for removably securing one structure to another structure are also within the scope of this invention.

The preferred catalyst-alloy in one embodiment is comprised of common P1020 aluminum infused with galinstan acting as a catalyst for the purpose of depassivating the aluminum when water is added. After water is added, the alloy becomes aluminum oxide (alumina) containing the catalyst.

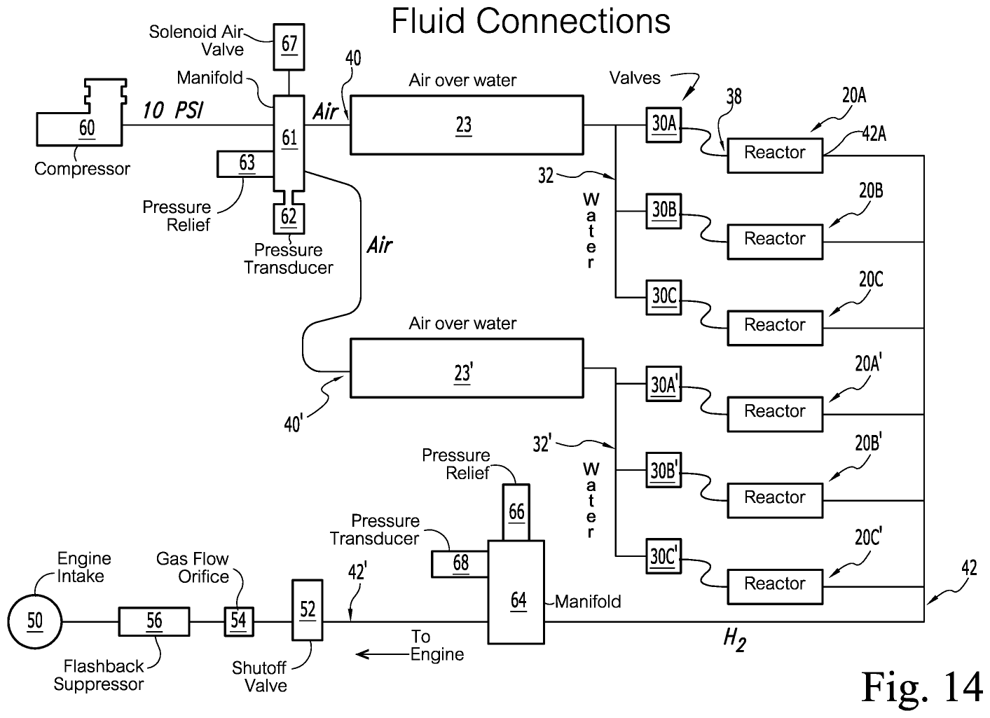

FIG. 13 is a schematic illustration depicting the fluid and electrical connections and conduits according to a current embodiment of the invention, while FIG. 14 is a schematic illustration of the fluid connections only of the apparatus according to a preferred embodiment of this invention. Gas train 24 preferably includes two manifolds 61, 64. A first manifold 61 directs the compressed air to the various compressed lines while also providing porting for a first solenoid air valve 67 (FIG. 14), an overpressure safety blow off valve 63, and a first pressure transducer 62. A second manifold 64 provides a central point for the hydrogen generated from the reactor modules 20, 20′ and mounts points for the gas line to the final delivery conduit 42, a second overpressure safety blow off valve 66, a shutoff valve 52, and a second pressure transducer 68. The hydrogen manifold 64 also provides a place to conduct the heat from the reacted gas into the body of enclosure 10.

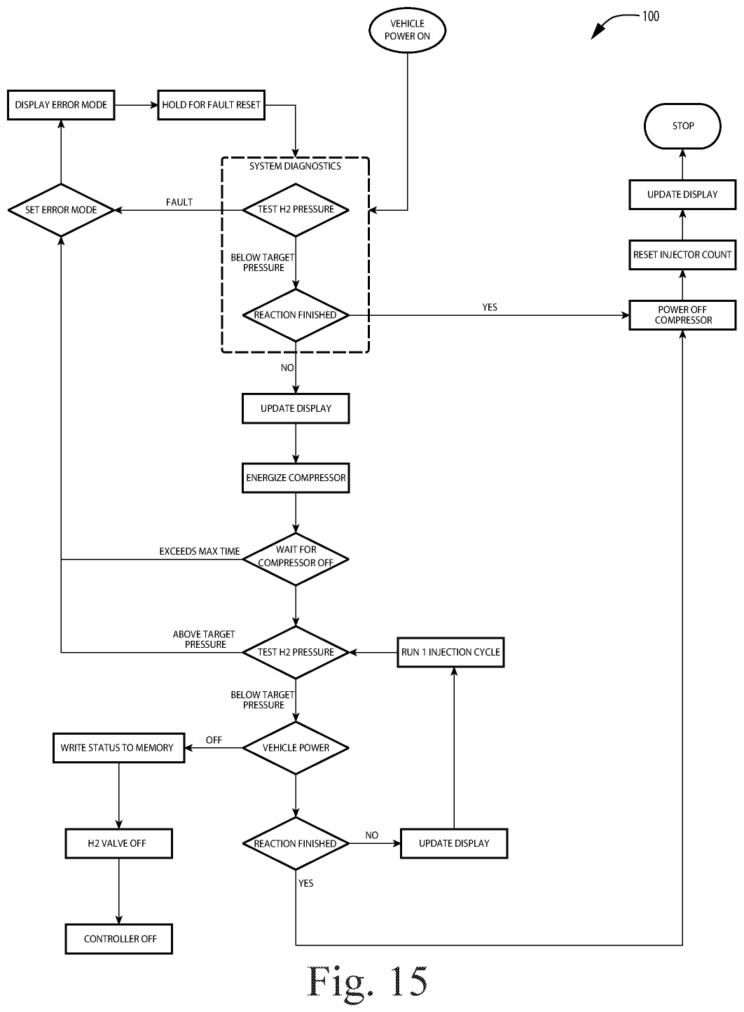

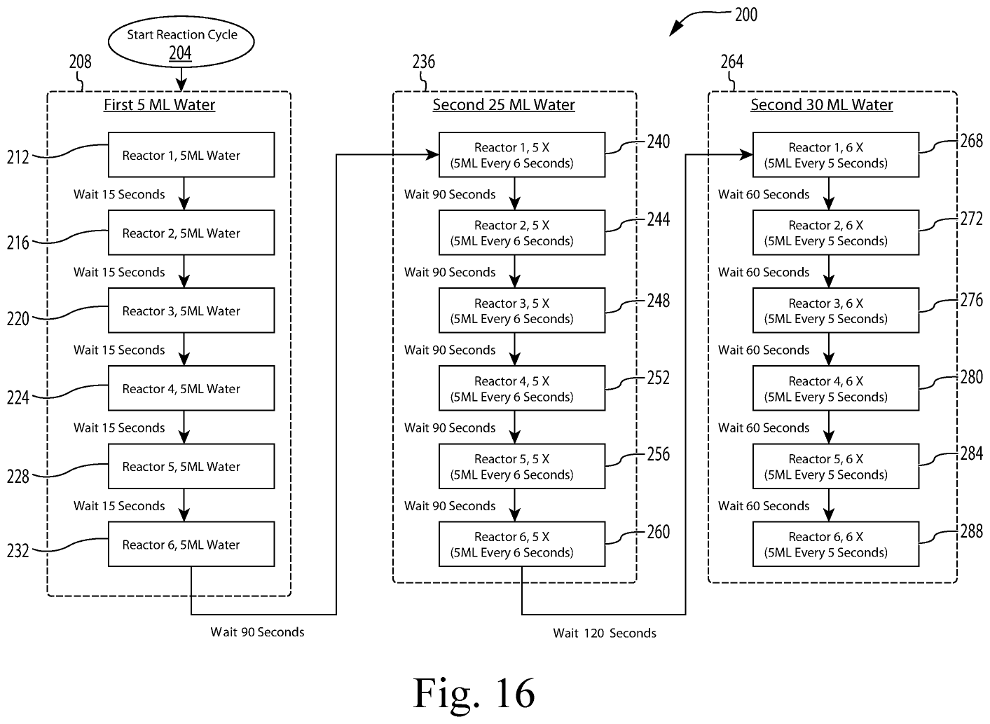

The air and water connections include a compressor 60 that provides compressed air at about 10 PSI to first manifold 61 coupled to first pressure transducer 62. Upon being activated by controller 26, manifold 61 introduces pressurized air via air inlets 40, 40′ to water vessels 23, 23′, which in turn inject water through first water conduits 32, 32′ to water valves 30A-30C and 30A′-30C′. Upon activation at step 212 of first stage 208, valve 30A injects 5 mL of water at inlet 38 to the interior of first reactor 20A. After step 212 is completed and 15 seconds transpires, valve 30B injects 5 mL of water into the interior of the second reactor 20B. This sequence continues in accordance with the automated processes 100 and 200 as shown and described in relation to FIGS. 15 and 16. Hydrogen, which is then being generated within each reactor 20A-20C′, is carried off via H₂ outlet 42A and first H₂ conduit 42. Conduit 42 is coupled to second manifold 64, which in turn is coupled to second pressure relief valve 66 and second pressure transducer 68, for selectively delivering H₂ to, in this instance, an ICE intake 50 via second H₂ conduit 42′. Between manifold 64 and the ICE intake 50, the second H₂ conduit 42′ of this invention further preferably includes a shutoff valve 52, a gas flow orifice 54, and a flashback suppressor 56.

FIG. 15 is a flow chart illustrating an exemplary automated process 100 for generating hydrogen on demand according to a currently preferred embodiment of the invention. More particularly, process 100 shows an example of the automated system executed by the system's controller 26 to complete the reaction of the alloy in the multiple reactors 20A-20C′. In operation, upon the vehicle ignition being activated, controller 26, preferably powered by the vehicle's battery and ignition voltage, receives various inputs from the compressed air pressure transducer 62, the hydrogen pressure transducer 68, a combustible gas detector 69, and reactor identification via ID chip or RFID (not shown), in order to confirm the current phase of the reaction process, and then determines which step(s) shall be performed next. More specifically, after confirming the system's current condition, including system errors, microcontroller 26 then initiates the hydrogen generation reaction, either from the beginning or at the point where the reaction was interrupted from the last vehicle shutdown. When the ignition is deactivated (shut off), microcontroller 26 saves the point at which the reaction had progressed for the next vehicle start up. Controller 26 may also provide an optional data logger for system troubleshooting, debugging information, and live data transmission through various platforms, including but not limited to Bluetooth, WIFI, and cellular.

FIG. 16 is a flow chart illustrating an exemplary automated process 200 for introducing water into the reactor modules 20A-20C for generating hydrogen according to this invention. Upon the initiation of the reaction cycle by controller 26, as set forth in step 204, a first water amount (preferably 5 milliliters (mL)) is added to each of the reactors 20A-20C during a first stage 208. During this first stage 208, a first amount of water (5 mL) is injected into reactor 20A, as set forth in step 212. After fifteen seconds (15 s.), 5 ML of water is injected into the second reactor 20B, as set forth in step 216. After step 216, 5 mL of water is also injected after fifteen seconds (15 s.) into the third reactor 20C, as set forth in step 220. After step 220 and after another fifteen seconds (15 s.), 5 mL of water is injected into the fourth reactor 20A′, as set forth in step 224. After step 224, and after another fifteen seconds (15 s.), 5 ml of water is injected into a fifth reactor 20B′, as set forth in step 228. After step 228, and after another fifteen seconds (15 s.), 5 mL of water is injected into the sixth reactor 20C′, as set forth in step 232.

After the first stage 208 has taken place and the passage of ninety seconds (90 s.) has transpired, a second stage 236 is initiated. As an initial step 240 of second stage 236, 5 mL of water is injected into the first reactor 20A every six seconds (6 s.) for five repetitive cycles. After step 240, and the passage of another ninety seconds (90 s.), 5 mL of water is injected into the second reactor 20B every six seconds (6 s.) for five repetitive cycles, as set forth in step 244. After step 244, and another ninety seconds (90 s.), 5 mL of water is injected into the third reactor 20C every six seconds (6 s.) for five repetitive cycles, as set forth in step 248. After step 248, and another ninety seconds (90 s.), 5 mL of water is injected into the fourth reactor 20A′ every six seconds (6 s.) for five repetitive cycles, as set forth in step 252. After step 252, and another ninety seconds (90 s.), 5 mL of water is injected into the fifth reactor 20B′ every six seconds (6 s.) for five repetitive cycles, as set forth in step 256. After step 256, and another ninety seconds (90 s.) 5 mL of water is injected into the sixth reactor 20C′ every six seconds (6 s.) for five repetitive cycles, as set forth in step 260.

Once the second stage 236 is complete and another 120 seconds (120 s.) has passed, a third and final stage 264 is initiated. As an initial step in third stage 264, 5 mL of water is injected into the first reactor 20A every five seconds (5 s.) for six repetitive cycles, as set forth in step 268. After step 268, and another 60 seconds (60 s.), 5 mL of water is injected into the second reactor 20B every five seconds (5 s.) for six repetitive cycles, as set forth in step 272. After step 272, and another 60 seconds (60 s.), 5 mL of water is injected into the third reactor 20C every five seconds (5 s.) for six repetitive cycles, as set forth in step 276. After step 276, and another 60 seconds (60 s.), 5 mL of water is injected into the fourth reactor 20A′ every five seconds (5 s.) for six repetitive cycles, as set forth in step 280. After step 280, and another 60 seconds (60 s.), 5 mL of water is injected into the fifth reactor 20B′ every five seconds (5 s.) for six repetitive cycles, as set forth in step 284. After step 284, and another 60 seconds (60 s.), 5 mL of water is injected into the sixth reactor 20C′ every five seconds (5 s.) for six repetitive cycles, as set forth in step 288.

The apparatus enclosure 10 provided by this invention is portable and may be transferred and located wherever on-demand generation of hydrogen is needed. In one embodiment, enclosure 10 may be carried in a bed of a work truck or other vehicle for providing supplemental fuel to the ICE powering such vehicle. In other applications, the enclosure 10 may be deployed in a free-standing position wherever hydrogen may be useful as a fuel (primary or supplemental).

This novel technology provided by this invention as described herein is unique in several distinct ways, including, but not limited to:
1. Hydrogen is generated only as needed, reducing the need to store it in a high-pressure tank, which is the conventional means for handling and storing gasified hydrogen. Thus, impact risks from collision are minimized, especially when compared to compressed natural gas and propane systems.
2. Hydrogen is generated using water and the aforementioned specialized alloy. When water is brought into contact with the alloy, the oxygen atom is stripped away from the water molecule leaving only hydrogen to be fed into, in one embodiment, an ICE.
3. The waste product (spent alloy) from the reaction of this invention is common aluminum oxide, which is a non-harmful compound.
4. The “spent” alloy is recovered and can be continuously recycled, thereby reducing the cost of fuel to customers.
5. As noted above, no modifications need to be made to the engine's electronic control module (EMC). The system of this invention works using the current sensors and controls already installed and available on the vehicle. The introduction of hydrogen into the engine is sensed by the vehicles ECM, which in turn automatically reduces the quantity of gasoline introduced into the cylinders for combustion.

Certain desirable objectives met by this novel technology employed, in one embodiment, in combination within an ICE include:
1. Reduces the use of gasoline
2. Reduces the production of greenhouse gasses (CO, CO₂, NOx)
3. Increases fuel mileage
4. No specialized refueling infrastructure required
5. Refueling time for the system, currently under two (2) minutes, involves merely disconnecting and removing the reactor modules 20 and 20′ from within enclosure 10 and replacing them with new reactor modules containing a fresh supply of the catalyst-alloy placed within each reactor.
6. Meets EPA requirements for aftermarket add-on supplemental systems
7. No fuel storage is required, eliminating the need for special garage accommodations required by local Fire Marshalls.
8. No modification to engine or ECM required
9. Cost of the alloy utilized by this invention is competitive with gasoline prices
10. No specialized training required for refueling vehicles

The system of this invention has been tested in a standard municipal fleet vehicle. The truck is a 2008 Ford F-250, equipped with a Triton 5.4 liter gasoline V-8 engine. To collect fuel mileage data, an Auterra DashDyno system equipped with a Garmin GPS unit was deployed. This combination of devices utilizes data from the engine's OBD II port to provide fuel delivery per mile driven. While in daily operation, tests have shown an average of 15% increased fuel economy and an average of 20% reduction in CO₂ emissions. Actual sample fuel mileage data is displayed in Tables B and C below.

TABLE B
Fuel/Mileage Data from Testing Period 1

| | |
|---|---|
| Total Miles Traveled Hydrogen Off | 872.50 |
| Total Fuel Consumed Hydrogen Off | 68.05 |
| Fuel Efficiency Hydrogen Off (MPG) | 12.82 |
| Total Miles Traveled Hydrogen On | 293.20 |
| Total Fuel Consumed Hydrogen On | 19.86 |
| Fuel Efficiency Hydrogen On (MPG) | 14.7 |
| MPG Difference | 1.94 |
| MPG Boost | 15.15% |
| Overall Miles Traveled | 1383.00 |
| Overall Fuel Consumed | 102.62 |
| Overall Fuel Efficiency (MPG) | 13.48 |

TABLE C
Fuel/Mileage Data from Testing Period 2

| | |
|---|---|
| Total Miles Traveled Hydrogen Off | 1172.80 |
| Total Fuel Consumed Hydrogen Off | 91.62 |
| Fuel Efficiency Hydrogen Off (MPG) | 12.80 |
| Total Miles Traveled Hydrogen On | 402.60 |
| Total Fuel Consumed Hydrogen On | 27.21 |
| Fuel Efficiency Hydrogen On (MPG) | 14.80 |
| MPG Difference | 1.94 |
| MPG Boost | 15.15% |
| Overall Miles Traveled | 1927.30 |
| Overall Fuel Consumed | 143.05 |
| Overall Fuel Efficiency (MPG) | 13.47 |

The above Tables B and C present actual sample data from Auterra DashDyno and Garmin GPS units used on the test vehicle. The data shows the system increased vehicle fuel mileage by 15.2-15.6% (listed as MPG Boost in the tables above).

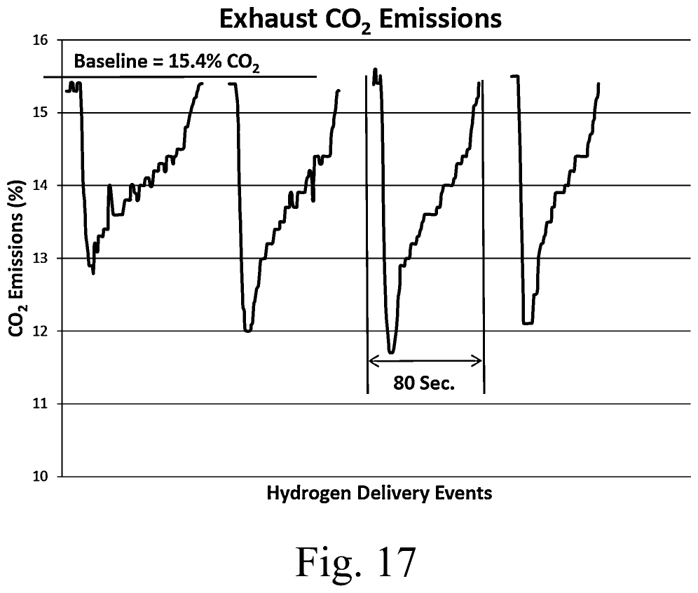

To collect the vehicle emissions output, an E-Instruments F-5000 five gas analyzer was employed to measure O₂, CO, CO₂, NOx, and HyCx. Data from this device is noted in FIG. 17. This graph depicts carbon dioxide (CO₂) emissions from the test vehicle during hydrogen delivery events. Referring now to FIG. 17, four (4) hydrogen deliver events are shown. During these events, the test vehicle decreased its CO2 emissions from a nominal 15.4% (baseline) to a low of 11.8%, representing a CO₂ reduction of 23.4%.

It should also be noted that no increase in NOx was experienced during these hydrogen delivery events depicted in FIG. 17. Due to hydrogen's increased burn temperatures, NOx production often increases. However, due to this system's novel design, the engine is not flooded with H₂, thereby obviating any excessive cylinder temperature increase. Instead, a constant flow of H₂ allows for more efficient operation of the engine without increasing NOX emissions.

To achieve these results, this invention deploys a proprietary alloy of aluminum and catalyst to separate hydrogen from oxygen in water and then deliver the hydrogen to a vehicle's engine. The system is a stand-alone device taking advantage of the existing ECM's sensors and operation—the vehicle's standard controls are untouched. The system may also be transferred between multiple vehicles. Indeed, due to the system's stainless steel construction, it most likely will outlive the average fleet vehicle. Finally, hydrogen is not produced unless and until it is needed. By monitoring a signal from the vehicle's alternator, the system will not produce hydrogen until it receives a signal the engine is operating.

Another important advantage provided by this invention is that no additional infrastructure is required for refueling the system. Refueling simply involves removing the reactor container holding the exhausted alloy, replacing the spent container with a reactor container holding fresh alloy and refilling the water vessel. The entire process may be performed in less than two (2) minutes, unlike refueling a compressed gas or electric vehicle. Refueling may also be performed by existing garage staff. Replacement alloy in reaction containers can be supplied to the user should they desire to perform the refueling function internally.

In addition, due to the aftermarket bolt-on design of the current system, the EPA does not require retesting of vehicles to ensure compliance with federal regulations. The system of this invention does not introduce any foreign materials into the engine's gasoline feed line and does not modify the ECM. Thus, fleet managers do not have to undergo the certification procedures required for a complete vehicle conversion.

Much of the impetus for green fleet initiatives originates from political concerns. The goals involve reducing America's dependence on oil while reducing emissions from transportation sources. Fortunately, the current system provided by this invention addresses both issues by providing on-demand supplemental hydrogen from a completely renewable source. Thus, from a financial perspective, at least the following three (3) distinct advantages are provided by this invention.
1. Hedging the price of gasoline: The cyclical low of oil prices appears to have passed and an uptrend re-established. As the price of gasoline rises, it is possible to mitigate the cost increase by reducing demand for gasoline with its replacement by hydrogen. The cost of the present supplemental fuel is not contingent on commodity pricing as the spent aluminum-based allow is recycled without adding new material.
2. Cost differential between gasoline and Ethanol 85: The price of E-85 is typically less than gasoline. However, E-85 is estimated to lower fuel economy by roughly 15-20%. Since this system increases fuel mileage by roughly 15%, cheaper E-85 can be purchased and the inherent loss in mileage mitigated by the employment of the current invention. This will additionally save on fuel costs while reducing vehicle emissions even further.
3. Current alternative fuels: If a municipality or other fleet owner is already deploying some type of alternative fuel, another risk exists besides those already noted above. For many fleet operators, some form of grant, subsidy, or tax credit assisted in financing the system. With periodic changes in the administration at the federal level, the very real possibility exists of tax policy and mandates being altered or perhaps eliminated completely. Such actions could have a material impact on the operational and maintenance costs associated with current alternative fuels. Fortunately, this technology stands on its own without any form of local, state, or federal government assistance.

Another significant advantage provided by this invention is that there are minimal safety concerns with this novel system. The hydrogen is generated on demand eliminating on-board storage. In addition, no-high pressure refueling system is required. The vessel containing the alloy and water is common five-inch stainless steel, and is not operated at high pressure. The system is outfitted with automatic safety valves (such as pressure relief valve 66) allowing hydrogen to vent should a malfunction or accident occur. The hydrogen feed line 42′ also preferably incorporates back-flash suppressors preventing any flame from reaching the system back through the delivery line.

In the event the vehicle runs out of hydrogen, the vehicle will simply continue to operate on gasoline as normal. The only difference is the advantages of improved fuel mileage and lowered emissions will not occur until the reactors are refilled. Because there is no modification to the engine or ECM, the absence of hydrogen will not affect the vehicle's standard or typical performance.

The hydrogen generation system disclosed herein has applications in addition to use in automobiles. A potentially very large application of this technology is as an energy storage medium for electricity produced by renewable sources, i.e. wind and solar farms. A most important issue impacting alternative means of power production is a lack of storage for mitigating the intermittent nature of the wind and sun. Ideal conditions for wind speed often occur during the middle of the night when demand for electricity is lowest. Solar farms are similarly handicapped by cloudy days and nightfall. A much larger percentage of the potential of such sources could be engaged if the energy generated during times of excess supply over demand could be stored. By utilizing surplus electricity to smelt the alumina generated by this invention, surplus electricity can be, in essence converted and saved as alloy.

Embodiments of the present invention may be used with fuel cells. A fuel cell generates electricity via a chemical reaction. It is a much more efficient means of producing power than an ICE. Another important point is an operating fuel cell creates zero harmful emissions. Every fuel cell requires a source of hydrogen for operating, as well as heat in order to maximize efficiency. This novel process provides both hydrogen and heat as needed.

Currently, the market for fuel cell powered vehicles is quite small. As fuel cells become more viable, however, it is important to consider the infrastructure for recycling as spent aluminum alloy already exists in the form of smelting facilities located all across the globe.

Embodiments of the present invention may have military applications. The Achilles heel of American military projection is portable energy. A forward-operating base requires massive quantities of liquid fuels for efficient operation. The Department of Defense is the largest individual consumer of liquid fuels domestically. The transportation of the huge quantities of energy needed to fuel the military, especially into remote or hostile regions, is very high risk and very expensive.

For example, convoys of fuel trucks are an easy target for enemy combatants. It is much safer if a convoy contains aluminum alloy instead of volatile liquids. Upon arrival at the base, the alloy can be reacted with any type of water and the resultant hydrogen employed to operate standard generators. Not only are the drivers and escorts of the convoy much safer, but the generators will produce no harmful emissions while in operation. When the trucks depart the base to return to the fuel depot, they can carry the previously reacted alloy. The aluminum industry can then recycle the spent alloy and return it to the appropriate depot for the next convoy.

Applicant has already demonstrated the ability to power in-whole U.S. Army generators normally operated on standard JP 8 fuel. The same system can be used in emergency applications for standby power during natural disasters when the existing infrastructure is destroyed or off-line. Instead of storing liquid fuels for generators, it is much safer to store the aluminum alloy where needed. When disaster strikes, simply adding any type of water to the alloy allows one to employ the hydrogen to operate power generators.

As noted above, testing of the system included mounting the prototype hydrogen-delivery system onto a vehicle for actual on-road testing. (A standard, gasoline-powered Ford 5.4 Liter Triton V-8 F 250 pick-up truck was used as a beta test platform.) After extensive, on-road testing in everyday use, the performance of the supplemental hydrogen delivery system is now well-established. Fuel savings is roughly 15% as the engine leans its use of gasoline as hydrogen burns first due to its higher propagation rate. CO₂ emissions are reduced approximately 20% without any increase in NOx emissions. By building from the data learned during live testing, the system no longer needs ASME certification as the operating pressure has dropped from initially 50 PSI down to 11 PSI currently.

Various embodiments of different embodiments of the present disclosure are expressed in paragraphs X1, X2 and X3 as follows:

X1. One embodiment of the present disclosure includes an apparatus for generating hydrogen on demand, comprising: a vessel for liquid feedstock, the vessel including an inlet for compressed air, and an outlet for liquid feedstock; and at least one reactor, the at least one reactor including an inlet in communication with the outlet for liquid feedstock and an outlet for hydrogen gas, the at least one reactor containing a solid alloy of aluminum and catalyst.

X2. Another embodiment of the present disclosure includes a method for generating hydrogen comprising: providing a first reactor containing a solid alloy containing aluminum and a catalyst; injecting, at an injection pressure, a first amount of liquid feedstock into the first reactor, wherein contact between the solid alloy and the liquid feedstock generates hydrogen; monitoring a gaseous pressure of the generated hydrogen; and controlling the injection pressure to maintain the injection pressure at a predetermined level above the gaseous pressure of generated hydrogen.

X3. A further embodiment of the present disclosure includes a method for generating hydrogen comprising: providing a plurality of reactors, each containing a solid alloy containing aluminum and a catalyst; injecting a first amount of liquid feedstock into each of the plurality of reactors, wherein injecting the first amount of liquid feedstock into a first reactor in the plurality of reactors occurs prior to injecting the first amount of liquid feedstock into a second reactor in the plurality of reactors; delaying for a first predetermined inter-stage duration; injecting a second amount of liquid feedstock into each of the plurality of reactors, wherein injecting the second amount of liquid feedstock into the first reactor occurs prior to injecting the second amount of liquid feedstock into the second reactor; delaying for a second predetermined inter-stage duration; and injecting a third amount of liquid feedstock into each of the plurality of reactors, wherein injecting the third amount of liquid feedstock into the first reactor occurs prior to injecting the third amount of liquid feedstock into the second reactor; wherein contact between the solid alloy and the liquid feedstock generates hydrogen.

Yet other embodiments include the features described in any of the previous paragraphs X1, X2 or X3, as combined with one or more of the following aspects:

Wherein the liquid feedstock is a hydrogen-containing oxidant.

Wherein the liquid feedstock comprises water.

Wherein the liquid feedstock is water.

Wherein the catalyst includes gallium.

Wherein the catalyst includes galistan.

Wherein the catalyst is galinstan.

Wherein the solid alloy is composed of about 90% aluminum and about 10% catalyst.

Wherein the solid alloy is composed of at least 90% aluminum and more than 0%, but not more than 10%, catalyst.

Further including a vented enclosure, wherein the vessel and the at least one reactor are contained within the vented enclosure.

Wherein the enclosure includes a lid panel securable in a closed position by one or more compression lever locks.

Wherein the lid carries one or more compressible bumpers.

Wherein the at least one reactor is carried within the enclosure abutting a reactor saddle.

Wherein the vessel for liquid feedstock includes a pickup tube extending within the vessel from the outlet for liquid feedstock.

Wherein introduction of compressed air into the liquid feedstock vessel via the inlet for compressed air forces liquid feedstock within the vessel through the pickup tube and outlet for liquid feedstock into a first water conduit, wherein the first water conduit is in communication with the inlet of the at least one reactor.

Further comprising a gas train providing a path for compressed air to enter the vessel and a separate path for hydrogen gas to exit the reactor.

Wherein the gas train directs hydrogen gas exiting the reactor to one of an internal combustion engine and a fuel cell.

Wherein the solid alloy is suspended within the at least one reactor.

Wherein the solid alloy is spaced apart from an interior wall of the at least one reactor.

Wherein the solid alloy is carried on a spring holder spaced apart from the interior wall of the at least one reactor.

Wherein the spring holder includes one or more gaps.

Wherein a bracket attaches the spring holder to the interior wall of the at least one reactor.

Wherein the at least one reactor includes a hood positioned between the inlet and the solid alloy.

Wherein the hood is generally conical in shape.

Wherein the at least one reactor includes a diverter, and is configured whereby the solid alloy is positioned between the diverter and the inlet.

Wherein the diverter is generally conical in shape.

Wherein the at least one reactor includes a hood and a diverter, and is configured such that, when liquid feedstock enters the least one reactor via the inlet, the liquid feedstock sequentially contacts the hood, the solid alloy, and then the diverter.

Further comprising providing a second reactor including a solid alloy containing aluminum and the catalyst; injecting, at the injection pressure, a second amount of liquid feedstock into the second reactor, wherein contact between the solid alloy and the liquid feedstock generates hydrogen, and wherein the injecting the second amount of liquid feedstock into the second reactor occurs a predetermined duration after injecting the first amount of liquid feedstock into the first reactor.

Wherein injection pressure is maintained at about 6 pounds per square inch above the gaseous pressure of generated hydrogen.

Further comprising providing a vessel for liquid feedstock, the vessel including an outlet operatively connected to the first reactor.

Wherein the controlling the injection pressure comprises controlling the introduction of compressed air into the vessel.

Wherein injecting the second amount of liquid feedstock into each of the plurality of reactors comprises delivering multiple injections to the first reactor prior to delivering multiple injections to the second reactor.

Wherein injecting the third amount of liquid feedstock into each of the plurality of reactors comprises delivering multiple injections to the first reactor prior to delivering multiple injections to the second reactor.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed:

1. An apparatus for generating hydrogen on demand, comprising:
a vessel for liquid feedstock, the vessel including an inlet for compressed air, and an outlet for liquid feedstock; and
at least one reactor, the at least one reactor including an inlet in communication with the outlet for liquid feedstock and an outlet for hydrogen gas, the at least one reactor containing a solid alloy of aluminum and catalyst.

2. The apparatus of claim 1, wherein the liquid feedstock is water.

3. The apparatus of claim 1, wherein the catalyst includes gallium.

4. The apparatus of claim 3, wherein the catalyst includes galinstan.

5. The apparatus of claim 1, wherein the solid alloy is composed of about 90% aluminum and about 10% catalyst.

6. The apparatus of claim 1, wherein the solid alloy is composed of at least 90% aluminum and more than 0%, but not more than 10%, catalyst.

7. The apparatus of claim 1, further including a vented enclosure, wherein the vessel and the at least one reactor are contained within the vented enclosure.

8. The apparatus of claim 7 wherein the enclosure includes a lid panel securable in a closed position by one or more compression lever locks.

9. The apparatus of claim 8 wherein the lid carries one or more compressible bumpers.

10. The apparatus of claim 7 wherein the at least one reactor is carried within the enclosure abutting a reactor saddle.

11. The apparatus of claim 1, wherein the vessel for liquid feedstock includes a pickup tube extending within the vessel from the outlet for liquid feedstock.

12. The apparatus of claim 11, wherein introduction of compressed air into the liquid feedstock vessel via the inlet for compressed air forces liquid feedstock within the vessel through the pickup tube and outlet for liquid feedstock into a first water conduit, wherein the first water conduit is in communication with the inlet of the at least one reactor.

13. The apparatus of claim 1, further comprising a gas train providing a path for compressed air to enter the vessel and a separate path for hydrogen gas to exit the reactor.

14. The apparatus of claim 13, wherein the gas train directs hydrogen gas exiting the reactor to one of an internal combustion engine and a fuel cell.

15. The apparatus of claim 1, wherein the solid alloy is suspended within the at least one reactor.

16. The apparatus of claim 1, wherein the solid alloy is spaced apart from an interior wall of the at least one reactor.

17. The apparatus of claim 16, wherein the solid alloy is carried on a spring holder spaced apart from the interior wall of the at least one reactor.

18. The apparatus of claim 17, wherein the spring holder includes one or more gaps.

19. The apparatus of claim 17, wherein a bracket attaches the spring holder to the interior wall of the at least one reactor.

20. The apparatus of claim 1, wherein the at least one reactor includes a hood positioned between the inlet and the solid alloy.

21. The apparatus of claim 20, wherein the hood is generally conical in shape.

22. The apparatus of claim 1, wherein the at least one reactor includes a diverter, and is configured whereby the solid alloy is positioned between the diverter and the inlet.

23. The apparatus of claim 22, wherein the diverter is generally conical in shape.

24. The apparatus of claim 1, wherein the at least one reactor includes a hood and a diverter, and is configured such that, when liquid feedstock enters the least one reactor via the inlet, the liquid feedstock sequentially contacts the hood, the solid alloy, and then the diverter.

25. A method for generating hydrogen comprising:
providing a first reactor containing a solid alloy containing aluminum and a catalyst;
injecting, at an injection pressure, a first amount of liquid feedstock into the first reactor, wherein contact between the solid alloy and the liquid feedstock generates hydrogen;
monitoring a gaseous pressure of the generated hydrogen; and
controlling the injection pressure to maintain the injection pressure at a predetermined level above the gaseous pressure of generated hydrogen.

26. The method of claim 25, further comprising:
providing a second reactor including a solid alloy containing aluminum and the catalyst; and
injecting, at the injection pressure, a second amount of liquid feedstock into the second reactor, wherein contact between the solid alloy and the liquid feedstock generates hydrogen, and wherein the injecting the second amount of liquid feedstock into the second reactor occurs a predetermined duration after injecting the first amount of liquid feedstock into the first reactor.

27. The method of claim 25 wherein the liquid feedstock is a hydrogen-containing oxidant.

28. The method of claim 25 wherein the liquid feedstock comprises water.

29. The method of claim 25 wherein injection pressure is maintained at about 6 pounds per square inch above the gaseous pressure of generated hydrogen.

30. The method of claim 25, further comprising:
providing a vessel for liquid feedstock, the vessel including an outlet operatively connected to the first reactor.

31. The method of claim 30, wherein the controlling the injection pressure comprises controlling the introduction of compressed air into the vessel.

32. The method of claim 25, wherein the catalyst includes gallium.

33. The method of claim 32, wherein the catalyst is galistan.

34. A method for generating hydrogen comprising:
providing a plurality of reactors, each containing a solid alloy containing aluminum and a catalyst;
injecting a first amount of liquid feedstock into each of the plurality of reactors, wherein injecting the first amount of liquid feedstock into a first reactor in the plurality of reactors occurs prior to injecting the first amount of liquid feedstock into a second reactor in the plurality of reactors;
delaying for a first predetermined inter-stage duration;
injecting a second amount of liquid feedstock into each of the plurality of reactors, wherein injecting the second amount of liquid feedstock into the first reactor occurs prior to injecting the second amount of liquid feedstock into the second reactor;
delaying for a second predetermined inter-stage duration; and
injecting a third amount of liquid feedstock into each of the plurality of reactors, wherein injecting the third amount of liquid feedstock into the first reactor occurs prior to injecting the third amount of liquid feedstock into the second reactor;
wherein contact between the solid alloy and the liquid feedstock generates hydrogen.

35. The method of claim 34, wherein the catalyst is galistan.

36. The method of claim 34, wherein the liquid feedstock is a hydrogen-containing oxidant.

37. The method of claim 34, wherein the liquid feedstock is water.

38. The method of claim 34, wherein injecting the second amount of liquid feedstock into each of the plurality of reactors comprises delivering multiple injections to the first reactor prior to delivering multiple injections to the second reactor.

39. The method of claim 34, wherein injecting the third amount of liquid feedstock into each of the plurality of reactors comprises delivering multiple injections to the first reactor prior to delivering multiple injections to the second reactor.
